(19) United States
(12) Patent Application Publication
(10) Pub. No.: US 2006/0182841 A1
(43) Pub. Date: Aug. 17, 2006

(54) Apparatus for blow molding

(76) Inventors: Rick Rodriguez, Adrian, MI (US); Robert L. Padley JR., Brooklyn, MI (US); A. Dale Maddox, Tecumseh, MI (US)

Correspondence Address: MILACRON INC., 2090 FLORENCE AVE., CINCINNATI, OH, 45206, US

(21) Appl. No.: 11/059,278

(22) Filed: Feb. 16, 2005

(51) Int. Cl. B29C 49/64

(52) U.S. Cl. 425/526

(57) ABSTRACT

A molding tool for molding a substantially hollow article from a tubular parison comprises molding surfaces defining at least one cavity for forming a hollow portion of a molded article, the hollow portions having walls formed by expansion of the parison within the cavities and defining at least one solid area of the article to be molded attached to a wall of a hollow portion, the solid area comprising waste of the article as molded and the molding surfaces comprising surface undulations effective to improve the rate of heat transfer between the molding surfaces and the molding material comprising the solid areas. A mold assembly for molding hollow articles from tubular parisons comprises a molding tool in accordance with the invention. A blow molding machine comprises a mold assembly in accordance with the invention.

### I. BACKGROUND OF THE INVENTION

1. Field of the Invention

This invention relates generally to blow molding. In particular, this invention relates to tooling for blow molding.

2. Description of Related Art

Blow molding is a cyclic process wherein a parison of material in a moldable condition is centered on the parting plane of a mold assembly, the mold assembly is closed around the parison, the parison is expanded so the exterior of the parison abuts molding surfaces defining a molding cavity of the closed mold assembly, the blow molded article is conditioned to be sufficiently rigid to retain its size and shape while unsupported, the mold assembly is opened and the blow molded article is removed. In general, the moldable condition of the parison is achieved when the material of the parison is at an elevated temperature, and the rigid condition of the blow molded article is achieved when the temperature of the material has been reduced. A blow molding machine comprises a press for opening and closing the mold assembly, blowing means for introducing a pressurized fluid (typically air) to expand the parison in the mold assembly, and means for removing the blow molded article from the mold assembly, for example manipulating means for grasping the article. Additionally, a blow molding machine may comprise heat transfer devices to elevate the temperature of the parison to achieve the moldable condition and to reduce the temperature of the blow molded article to achieve the rigid condition.

Extrusion blow molding is commonly used for production of hollow objects including containers and tubular articles from tubular parisons extruded along a central longitudinal axis of a molding cavity. To produce articles having non-uniform body portions, molding tools for extrusion blow molding include molding surfaces for capturing parison walls forming solid areas adjoining walls of hollow portions of articles being molded. These solid areas comprise waste of the articles as molded and are removed from the blow molded article. In the molding of containers comprising hollow handles or other hollow appendages open to the container body, solid areas may be formed between the appendage and the container body. In areas of captured parison, called “flash”, the parison wall is doubled over creating increased material thickness compared to wall thickness of the hollow portions of the article being molded. Material thickness is determined, at least in part, by such adjustment of processing parameters as affecting the condition of the material as extruded. In the course of production of articles, it is common for processing parameters to be adjusted to achieve a desired article weight. The areas of the molded article comprising doubled parison walls present greater thermal mass requiring transfer of heat to achieve the desired rigidity for removal of the molded article from the mold assembly. This increased thermal mass increases the time required to transfer sufficient heat from the material to attain the desired rigidity, increasing the overall time required to complete a molding cycle. As a consequence, known molding tools for blow molding hollow articles and comprising such solid areas are limited in their application in respect of the wall thickness of the parison from which the containers can be made with acceptable production rates at a desired article weight. Hence, there is a need for an improved molding tool that permits blow molding of such containers and overcomes the production rate limitations arising from the regions of increased material thickness in such solid areas.

### II. SUMMARY OF THE INVENTION

It is an object of the present invention to provide a molding tool for molding a substantially hollow article from a tubular parison the molding tool comprising molding surfaces defining at least one cavity for forming a hollow portion of a molded article, the hollow portion having walls formed by expansion of the parison within the cavities, and further defining at least one solid area of the article to be molded attached to a wall of a hollow portion, each solid area comprising waste of the article as molded and the molding surfaces comprising surface undulations effective to improve the rate of heat transfer between the tool and molding material comprising the solid areas.

It is a further object of the present invention to provide a mold assembly comprising a molding tool in accordance with the invention.

It is a still further object of the present invention to provide a blow molding machine comprising a mold assembly in accordance with the invention.

Further objects and advantages of the invention shall be made apparent from the accompanying drawings and the following description thereof.

In accordance with the aforesaid objects the present invention provides a molding tool for molding a substantially hollow article from a tubular parison, the molding tool comprising first molding surfaces defining a primary cavity for forming a hollow body portion of a molded article, the body portion having walls formed by expansion of the parison within the primary cavity, and second molding surfaces defining at least one first solid area of the article to be molded attached to a wall of the hollow body portion, the first solid area comprising waste of the article as molded and the second molding surfaces having surface undulations effective to improve the rate of heat transfer between the tool and molding material comprising the first solid area. A mold assembly for molding hollow articles from tubular parisons comprises a molding tool in accordance with the invention. A blow molding machine comprises a mold assembly in accordance with the invention.

### III. BRIEF DESCRIPTION OF THE DRAWINGS

FIG. 1 is a three dimensional view of a mold assembly having a molding tool in accordance with the invention.

FIGS. 2a and 2b are three dimensional views of a component of the mold assembly of FIG. 1 and an insert therefore (shown enlarged).

FIG. 3 is a front view of the mold assembly component of FIG. 2.

FIG. 4 is a partial cross section of a portion of the mold assembly component of FIG. 3 showing the profile of the molding surfaces thereof.

### IV. DETAILED DESCRIPTION OF THE PREFERRED EMBODIMENT

The invention shall be illustrated with reference to a preferred embodiment which shall be described in detail. It is not the intention of applicant that the invention be limited to the preferred embodiment, but rather that the invention shall be defined by the appended claims and all equivalents thereof.

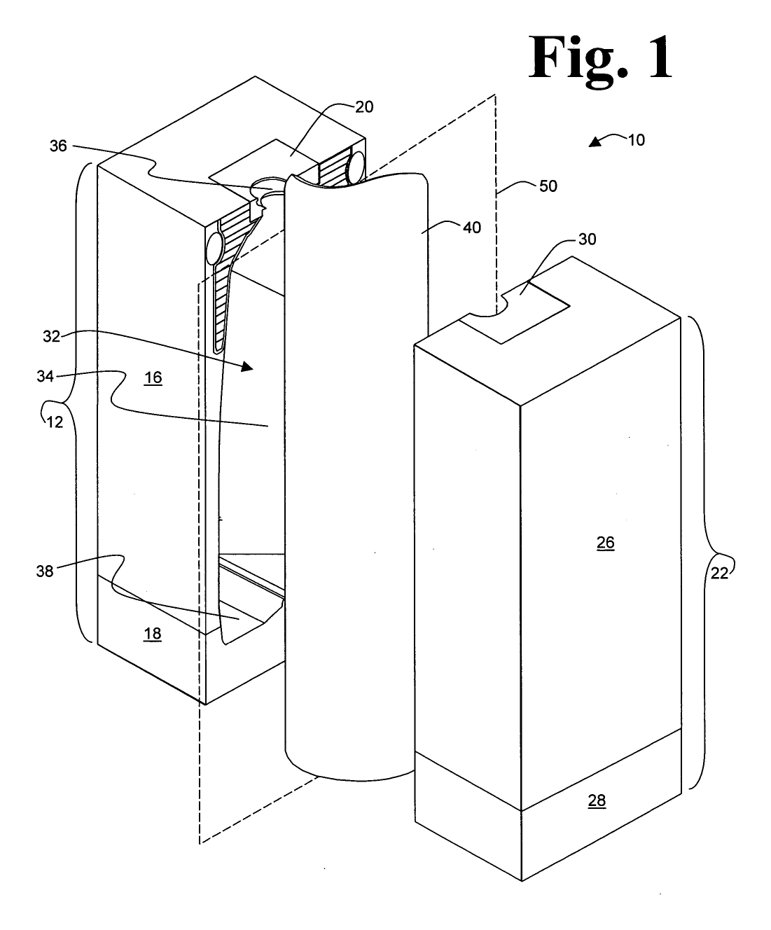

Referring to FIG. 1, mold assembly 10 comprises mating mold components 12 and 22 each referred to herein as a “mold half” or “molding tool”. Each of mold components 12 and 22 is carried by a member of a molding machine press (not shown) for translating the mold components between open and closed positions relative to each other (the open position depicted in FIG. 1). In the open position, mold components 12 and 22 are separated permitting admission of a parison such as parison 40 therebetween and removal of a molded article upon completion of a molding operation. In the closed position, mold components 12 and 22 abut at parting plane 50, the abutting faces of mold components 12 and 22 having molding surfaces open thereto defining at least one cavity. The cavity shown in FIG. 1 is a cavity for blow molding a container having an integral hollow handle as is known for storing and dispensing fluids, such as a milk jug or other beverage container. Parison 40 is tubular, typically produced by extrusion of flowable material through a die (not shown) above mold assembly 10. Parison 40 is formed as a single continuous tubular extrusion with a length extending below the lowest molding surface of the cavity. With the molds closed surrounding the parison, the parison is pinched closed at the base molding surface and pressurized through the open end at the neck of the cavity to expand the parison material to abut the molding surfaces of the cavity.

Continuing with reference to FIG. 1, the portion 32 of the cavity defined by mold component 12 comprises molding surfaces 34, 36 and 38. Molding surfaces 34 define the body of the container comprising a primary cavity; molding surfaces 36 define the neck portion of the container and, molding surfaces 38 define the base portion of the container. Mold component 12 comprises center section 16 comprising molding surfaces 34, base section 18 comprising molding surfaces 38 and insert 20 comprising molding surfaces 36. The corresponding sections of mold component 22 are center section 26, base section 28 and insert 30. Each of sections 22-30 comprise molding surfaces substantially mirroring molding surfaces 34, 36 and 38, respectively.

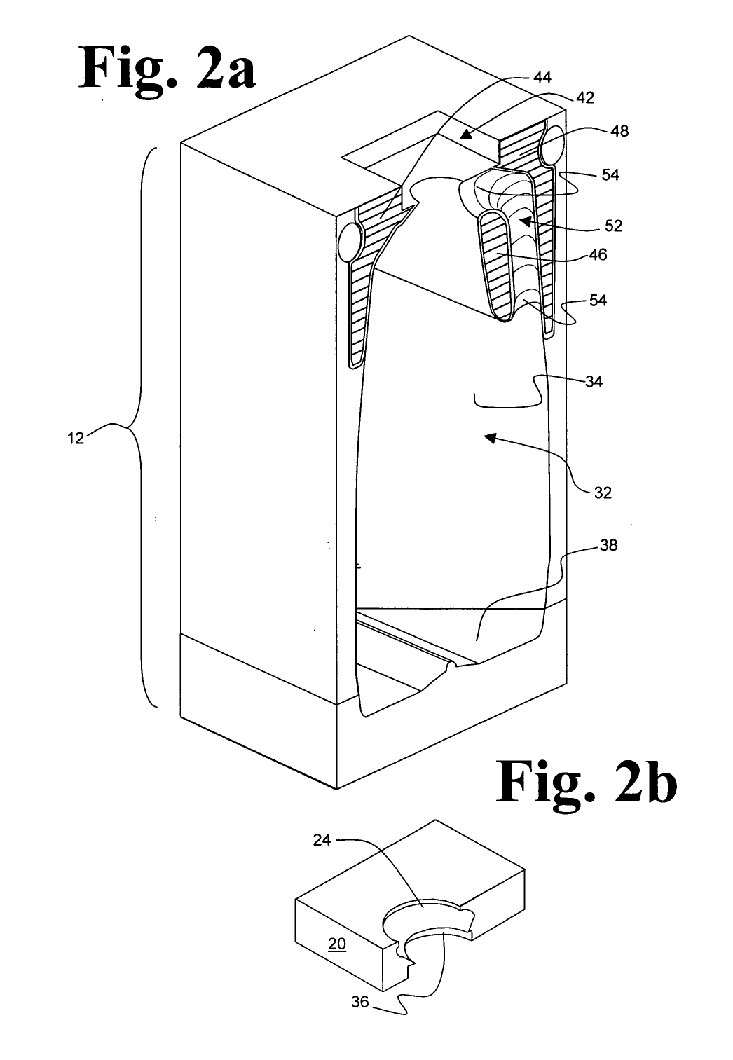

As is customary, molding surfaces defining the neck portion of containers to be molded comprise replaceable inserts attached to the mating mold components. Referring to FIGS. 2a and 2b, mold component 12 is shown with insert 20 removed. Mold component 12 comprises recess 42 for receiving insert 20. Inserts 20 and 30 comprise molding surfaces 36 defining a dome and neck finish of the container. The dome comprises waste of the article as molded and is parted from the neck finish after blow molding. The neck finish is formed to engage a closure (not shown) and may comprise threads or other surface features for that purpose. A parting groove is formed in the periphery of the molded article between the neck finish and dome of the container by a relatively sharp edge comprising surfaces 36 of insert 20. Upon closure of the mold assembly 10 around parison 40, the lower end of parison 40 below molding surfaces 38 is pinched closed. Parison 40 is pressurized via blowing means (not shown) comprising the blow molding machine and forming a seal with parison 40 at opening 24 in insert 20.

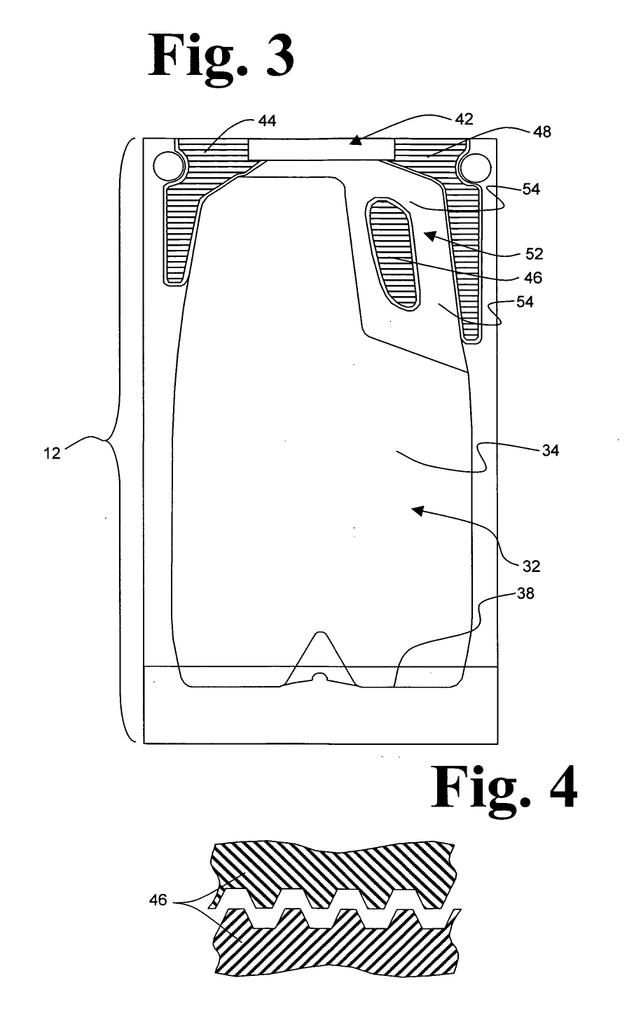

Referring to FIG. 2a mold component 12 comprises secondary cavity 52 defined by molding surfaces 54 and defining a hollow appendage, as shown, a hollow handle, which is open to and joined with the body portion of the container. The hollow handle rises from the container body at a shoulder thereon and rejoins the container just below the neck portion. Referring to FIGS. 2a and 3, molding surfaces of mold component 12 wherein walls of parison 40 are to be captured on mold closure and comprising waste of the article as molded include molding surfaces 44, 46 and 48. Secondary cavity 52 bounds molding surface 46 which adjoins a wall of the body portion of the container to be molded. Molding surfaces 44 and 48 result from sizing of the parison according to the maximum width of the cavity and the narrower width at the upper end of the cavity. Corresponding molding surfaces are present in mold component 22.

With the mold closed, walls of the captured parison are brought into abutment at all of molding surfaces 44, 46 and 48 creating solid areas of the article being molded. The resultant effective doubling of material thickness at molding surfaces 44, 46 and 48 increases the time required for transfer of sufficient heat from the material to achieve the desired rigidity for removal of the molded article from the mold assembly. The planar surface area of each of molding surfaces 44, 46 and 48 defines the area of parison walls captured on mold closure. In accordance with the invention additional effective surface area of molding surfaces 44, 46 and 48 is provided by undulating surfaces of these molding surfaces. The surface undulations of molding surfaces 44, 46, and 48 increase the surface area of captured material, tending to thin the thickness of the captured parison walls as the material is made to conform to the undulating molding surfaces. The combination of increased surface area and reduced material thickness improves the effectiveness of heat transfer from the molding material comprising the solid areas and the molding tool compared to the heat transfer that would be achieved from the planar surface area circumscribed by the boundary of each of the molding surfaces 44, 46 and 48 at parting plane 50.

Referring to FIG. 4, partial cross sectional views of molding surfaces 46 of mating mold components 12 and 22 depict the intermeshing of surface undulations with mold closure. With the mold closed (depicted in FIG. 4), the gap between the mating molding surfaces 46 are filled with material comprising the solid areas of the molded article. The gap is chosen to provide clearance for the captured material sufficient to allow complete closure of the mold components while maintaining contact of the material with the undulations of molding surfaces 46. Although shown as a regular trapezoidal pattern, any surface undulation effective to increase the area of the molding surface in contact with the molding material is effective to improve heat transfer from the material. In this regard, the depth and pitch of surface undulation is designed to achieve substantial conformance of the molding material to the molding surfaces considering the flowable condition of the material and the forces acting thereon with mold closure.

Continuing with reference to FIG. 4, the surface undulations increase the effective surface areas of molding surfaces 46 compared to the planar areas circumscribed by the boundaries of molding surfaces 46 at parting plane 50. Additionally, the intermeshing of the undulations (as depicted for molding surfaces 46) force stretch of material captured at molding surfaces 44, 46, and 48, tending to reduce thickness of the captured material. The combined effect of increased surface area and reduction of material thickness improve the effective rate of heat transfer from material captured at molding surfaces 44, 46 and 48. The improved rate of heat transfer allows a greater range of adjustment of processing parameters affecting article weight while maintaining acceptable production cycle times.

What is claimed is:

1. A molding tool for molding a substantially hollow article from a tubular parison, the molding tool comprising first molding surfaces defining at least one cavity for forming a hollow portion of a molded article, the hollow portion having walls formed by expansion of the parison within the cavity, and second molding surfaces defining at least one first solid area of the article to be molded attached to a wall of the hollow portion, the first solid area comprising waste of the article as molded and the second molding surfaces having surface undulations effective to improve the rate of heat transfer between the tool and molding material comprising the first solid area.

2. The molding tool according to claim 1 further comprising third molding surfaces defining a cavity for forming a hollow appendage open to the interior of the hollow portion defined by the first molding surfaces and at least one second solid area joined to the appendage, the second solid area comprising waste of the article as molded and the third molding surfaces comprising surface undulations effective to improve the rate of heat transfer between the tool and molding material comprising the second solid area.

3. The molding tool according to claim 2 wherein the second solid area is bounded by the hollow appendage and a wall of the body portion.

4. The molding tool according to claim 2 wherein the third molding surfaces define a third solid area joined to the appendage, the third solid area comprising waste of the article as molded and the third molding surfaces comprising surface undulations effective to improve the rate of heat transfer between the tool and molding material comprising the third solid area.

5. A mold assembly for blow molding a substantially hollow article from a tubular parison, the mold assembly comprising first and second mating mold components, each mating mold component comprising molding surfaces open to a mating face of the mold component and defining the exterior of an article to be molded, the molding surfaces comprising first molding surfaces defining at least one cavity for forming a hollow portion of a molded article, the hollow portion having walls formed by expansion of the parison within the cavity and second molding surfaces defining at least one first solid area of the article to be molded attached to a wall of the hollow portion, the first solid area comprising waste of the article as molded and the second molding surfaces having surface undulations formed therein effective to improve the rate of heat transfer between the second molding surfaces and molding material comprising the first solid area.

6. The mold assembly according to claim 5 wherein molding surfaces of each mating mold component further comprise third molding surfaces defining a cavity for forming a hollow appendage open to the interior of the hollow portion defined by the first molding surfaces and at least one second solid area joined to the appendage, the second solid area comprising waste of the article as molded and the third molding surfaces comprise surface undulations effective to improve the rate of heat transfer between the third molding surfaces and molding material comprising the second solid area.

7. The mold assembly according to claim 6 wherein the second solid area is bounded by the hollow appendage and a wall of the body portion.

8. The mold assembly according to claim 6 wherein the third molding surfaces define a third solid area joined to the appendage, the third solid area comprising waste of the article as molded and the third molding surfaces comprise surface undulations effective to improve the rate of heat transfer between the third molding surfaces and molding material comprising the third solid area.

9. A blow molding machine comprising a press mechanism for operating a mold assembly, the mold assembly comprising first and second mating mold components, each mating mold component comprising molding surfaces open to a mating face of the mold component and defining the exterior of at least one substantially hollow article to be molded from a tubular parison, the molding surfaces comprising first molding surfaces defining a cavity for forming a hollow portion of a molded article, the hollow portion having walls formed by expansion of the parison within the cavity and second molding surfaces defining at least one first solid area of the article to be molded attached to a wall of the hollow portion, the first solid area comprising waste of the article as molded and the second molding surfaces having surface undulations effective to improve the rate of heat transfer between the second molding surfaces and molding material comprising the first solid area.

10. The blow molding machine according to claim 9 wherein molding surfaces of each mating mold component further comprise third molding surfaces defining a cavity for forming a hollow appendage open to the interior of the hollow portion defined by the first molding surfaces and at least one second solid area joined to the appendage, the second solid area comprising waste of the article as molded and the third molding surfaces comprise surface undulations effective to improve the rate of heat transfer between the third molding surfaces and molding material comprising the second solid area.

11. The blow molding machine according to claim 10 wherein the second solid area is bounded by the hollow appendage and a wall of the body portion.

12. The blow molding machine according to claim 10 wherein the third molding surfaces define a third solid area joined to the appendage, the third solid area comprising waste of the article as molded and the third molding surfaces comprise surface undulations formed therein effective to improve the rate of heat transfer between the third molding surfaces and molding material comprising the third solid area.
